(19) United States
(12) Patent Application Publication
(10) Pub. No.: US 2006/0244422 A1
(43) Pub. Date: Nov. 2, 2006

(54) Methods and apparatus for charging a power source

(76) Inventors: Robert W. DiGiovanna, Shirley, NY (US); Daniel Gonzalez, Setauket, NY (US); Christopher P. Klicpera, Minneola, NY (US)

Correspondence Address: FAY KAPLUN & MARCIN, LLP, 15O BROADWAY, SUITE 702, NEW YORK, NY, 10038, US

(21) Appl. No.: 11/116,257

(22) Filed: Apr. 27, 2005

(51) Int. Cl. H02J 7/00

(52) U.S. Cl. 320/137

(57) ABSTRACT

Methods and apparatus for charging a power source comprising determining a type of power supply used by a base, communicating a charge rate to a power source charging module and providing power to the power source at a charge rate. In one embodiment, a scanner can recharge from a cradle that receives power from either a dedicated external power source or through USB by adjusting its charge rate based on a communication from the base.

### FIELD OF THE INVENTION

The invention is directed to the powering of electronic devices and, more particularly to methods and apparatus for charging a power source, such as, for example, a rechargeable battery.

### BACKGROUND OF THE INVENTION

Wireless electronic devices such as cell phones, handheld scanners, mobile computers, electronic pets, etc. normally comprise a rechargeable power source, such as, for example, a battery. The electronic device can be recharged by coupling the device to an accompanying base. The base can draw power from another battery, a communicant/power supply interface and/or an electrical outlet.

Some communication interfaces, such as, for example, the Universal Serial Bus (USB) interface, an IEEE 1394 interface, etc. can provide power to coupled devices as well as communicate data. These combination communication/power supply interfaces can have a maximum allowable current draw. For example in USB, the maximum allowable current draw from a USB host is 500 mA. This limit may not be as high as an electronic device could draw if the base was powered by another type of external power supply. If an electronic device attempts to draw a current amount over the limit, the USB host shuts off power to the base due to excessive current draw and the electronic device would not be recharged.

Accordingly, there is a desire for methods and apparatus for charging a power source from a base that can draw power from a plurality of different sources that may have a plurality of different current draw limits.

### SUMMARY OF THE INVENTION

The invention as described and claimed herein satisfies this and other needs, which will be apparent from the teachings herein. An embodiment of the invention includes methods and apparatus for charging a power source, such as, for example, a rechargeable battery.

An exemplary method of charging a power source comprises determining a type of power supply used by a base, communicating a charge rate to a power source charging module, and providing power to the power source at a charge rate. In an exemplary embodiment, the electronic device can be a scanner and the base can be a cradle.

The cradle can be coupled to a plurality of different power supplies, such as, for example, a dedicated power supply from an outlet and/or a communication/power supply interface. The communication/power supply interface can be, for example, a USB interface or an IEEE 1394 interface. The power source for the scanner charges at a rate that depends on the type of power supply used by the cradle. If the cradle uses a power supply that can handle higher current draws, then the scanner draws more current, and if the cradle uses a power supply that has a lower current draw limit, then the scanner limits its charge rate in accordance with the lower current draw limit.

In an embodiment of the invention, the scanner comprises a power source charging module, which charges the scanner's battery. In alternate embodiments, the power source module can be implemented as part of the cradle. Before or after the scanner is coupled to the cradle, the cradle sends a message to the scanner, telling it what at what rate it should charge its power source. The message can be as simple as a waveform signal and/or it can be a message that is part of a communication protocol between the cradle and the scanner.

After the scanner learns a charge rate, the scanner sends a control signal to the power source charging module, which prepares to charge the scanner's battery at an appropriate charge rate. In an embodiment, a power source charging module comprises at least two current sources. The charge rate can be controlled by the number of current sources that are used.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates and exemplary device implemented according to an embodiment of the invention.

FIG. 2 illustrates an exemplary base implemented according to an embodiment of the invention.

FIG. 3A illustrates an exemplary base side power source charging method implemented according to an embodiment of the invention.

FIG. 3B illustrates an exemplary power source charging implemented according to an embodiment of the invention.

FIG. 4 illustrates an exemplary scanner implemented according to an embodiment of the invention.

FIG. 5 illustrates an exemplary cradle implemented according to an embodiment of the invention.

FIG. 6 illustrates the scanner of FIG. 4 coupled to the cradle of FIG. 5.

FIG. 7 illustrates a block diagram illustrating exemplary modules of the scanner and cradle of FIGS. 4 and 5.

FIG. 8 illustrates an exemplary power source charging module implemented according to an embodiment of the invention.

FIG. 9 illustrates an alternate power source charging module implemented according to an embodiment of the invention.

### DETAILED DESCRIPTION OF EXEMPLARY EMBODIMENTS

There will now be shown and described in connection with the attached drawing figures several exemplary embodiments of methods and apparatus for charging a power source.

Electronic-devices often comprise rechargeable batteries as power supplies. Some of those devices can be coupled to a base to recharge their batteries. The base can be supplied with power through a number of different ways. For example, the base can be plugged into an outlet, it can draw power from another battery, or can be powered through a communication/power supply line, such as, for example, USB. The base can be configured to receive power from one method or through a plurality of different methods. Unfortunately, different power supplies may have different specifications, such as for example, maximum allowable current draws. Thus, if a device expects a first power supply and draws current at an acceptable level for that first power supply, but the base is being supplied by a second power supply with a lower maximum current draw, the base will stop charging the device.

This is not a desirable situation because the base has some power to recharge the device's battery, but it cannot because the device is drawing too much current. Thus, in an exemplary embodiment of the invention, a base determines the type or types of power supplies that it is using, and determines an appropriate charge rate for a coupled device. The charge rate is then communicated to a power source charging module. Using the power supply information, the power source charging module can then prepare to charge a device at an appropriate level. In alternate embodiments, the power source charging module can be located in the device or the base.

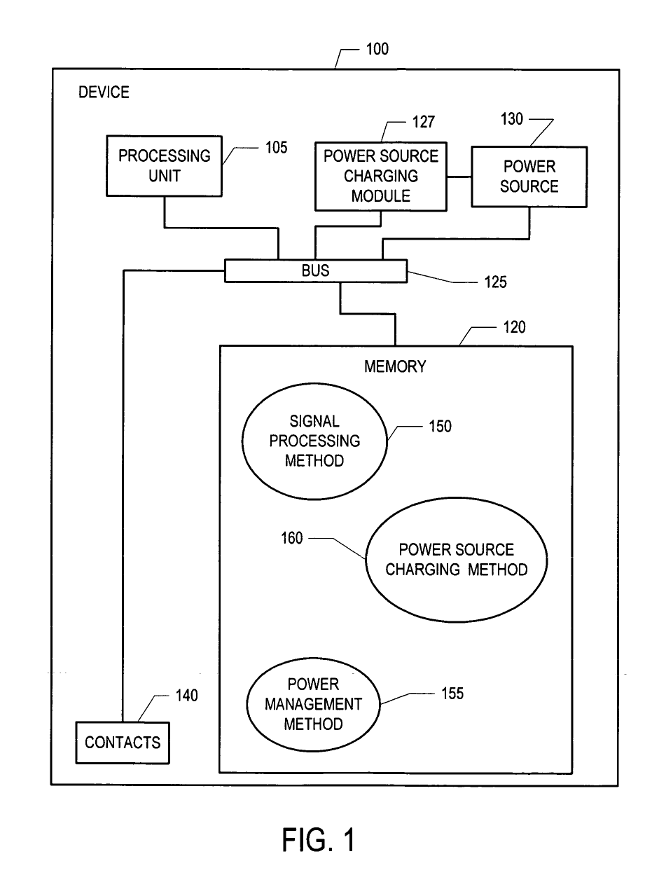

FIG. 1 illustrates an exemplary device 100 implemented in accordance with the invention. The device 100 can be, in exemplary embodiments, a handheld scanner, a mobile computer, a cell phone etc. The device 100 comprises a processing unit 105, a power source 130, power source charging module 127, contacts 140 and memory 120 coupled together by bus 125. The modules of device 100 can be implemented as any combination of software, hardware, hardware emulating software, and reprogrammable hardware. The bus 125 is an exemplary bus showing the interoperability of the different modules of the invention. As a matter of design choice there may be more than one bus, and in some embodiments certain modules may be directly coupled instead of coupled to a bus 125. Additionally, some modules may be combined with others.

When the device 100 is used in a mobile mode, the device 100 can receive power from power source 130, which can be a rechargeable battery or another source of electrical power. In addition, power source 130 can be a plurality of different power modules that work in conjunction or in a back up configuration. The device 100 can recharge its power source 130 through contacts 140. Contacts 140 can be, for example, exposed metal strips that align with contacts on a base, contacts in a slot for a wire that connects to a base, an electrical plug, etc. In addition to contacts 140 for recharging, device 100 can have additional contacts 140 that can be used for other purposes, such as, for example, communicating with the base.

Processing unit 105 can be implemented as, in exemplary embodiments, one or more Central Processing Units (CPU), Field-Programmable Gate Arrays (FPGA), etc. In an embodiment, the processing unit 105 can comprise a general purpose CPU that processes software and raw image data stored in memory 120. In other embodiments, modules of the processing unit 105 may be preprogrammed or hardwired in the processing unit's 105 memory to perform functions, such as, for example, signal processing, etc. In alternate embodiments, one or more modules of processing unit 105 can be implemented as an FPGA that can be loaded with different processes, for example, from memory 120, and perform a plurality of functions. Processing unit 105 can comprise any combination of the processors described above.

Memory 120 can be implemented as volatile memory, non-volatile memory and rewriteable memory, such as, for example, Random Access Memory (RAM), Read Only Memory (ROM) and/or flash memory. The memory 120 stores methods and processes used to operate the device 100. Different devices perform different functions, thus different devices store different methods in memory. An exemplary device, such as, for example, a handheld scanner, can comprise a signal processing method 150, a power source charging method 160 and a power management method 155. The memory 120 can also be used to store data, and as mentioned above, memory 120 can be part of processing unit 105.

In a scanner, when a decoding operation is initiated, for example, a trigger is pressed, the scanner 100 reads a target dataform, for example, a barcode, and analyzes the dataform. Signal processing method 150 is used by the scanner to decode dataforms. The scanner can be a laser scanner, imaging scanner, etc.

Power management method 155 manages the power used by a device 100. In some embodiments, the device 100 can switch to a power save mode, when no activity is detected for a given amount of time. The power save mode can completely shut down the device 100 or alternatively, it can slow down device operations, or initiate other power saving techniques.

In accordance with an embodiment of the invention, device 100 comprises power source charging method 160. In an embodiment of the invention, device 100 receives information from a base before the device 100 begins to charge. The information can comprise a charge rate the device uses to appropriately recharge its battery.

For example, an exemplary power source charging module 127 can comprise a current source and a battery charger. The current source can comprise two or more current sources, and the level of current drawn by the device 100 can be controlled by the number of current sources that are used. Thus, in an exemplary embodiment, when a base is supplied by a 110-volt outlet, the power source charging module 127 uses all its current sources and draws current at a high rate. When the base is supplied by a USB interface, the power source charging module 127 uses less than all its current sources and draws current at a lower rate.

In alternate embodiments, a power source charging module 127 can comprise a battery charger. The battery charger can charge a power source at different current levels based on a reference signal across one or more resistors. The reference signal can be controlled by switching off current to some of the resistors.

The exemplary embodiment of FIG. 1 illustrates signal processing method 150, power source charging method 160 and power management method 155 as separate components, but these methods are not limited to this configuration. Each method described herein in whole or in part can be separate components or can interoperate and share operations. Additionally, although the methods are depicted in the memory 120, in alternate embodiments the methods can be incorporated permanently or dynamically in the memory of processing unit 105.

Memory 120 is illustrated as a single module in FIG. 1, but in some embodiments device 100 can comprise more than one memory module. For example, the methods described above can be stored in separate memory modules.

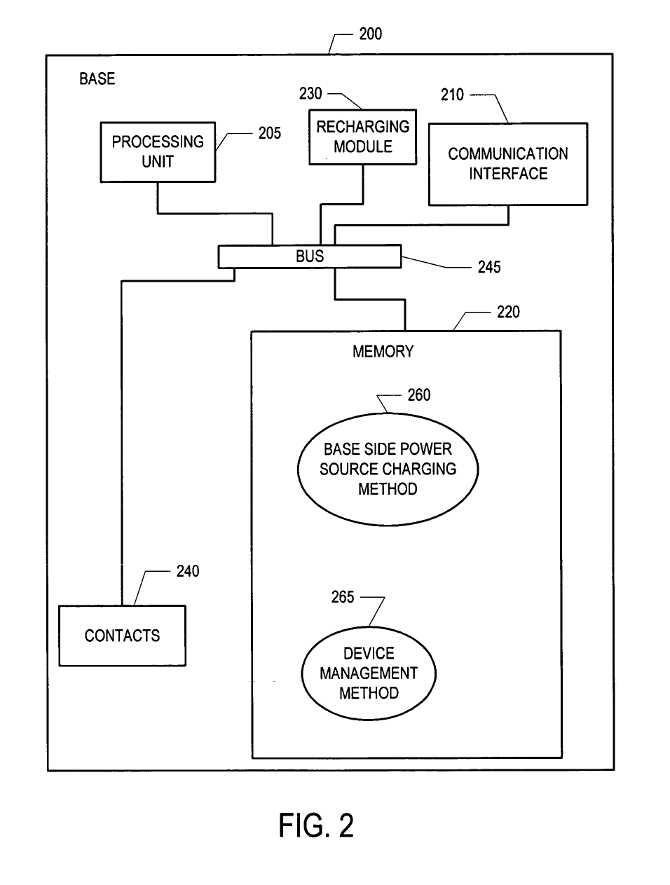

FIG. 2 illustrates an exemplary base 200 implemented in accordance with an embodiment of the invention. The base 200 comprises a processing unit 205, recharging module 230, communication interface 210, contacts 240 and memory 220 coupled together by bus 245. As with the device 100, the bus 245 of the base 200 illustrates the interoperability of the modules of base 200. In other embodiments, some modules of the base may be directly coupled together and/or incorporated within one another.

The processing unit 205 and the contacts 240 can be similar to the processing unit and contacts of the device 100. The level of “intelligence” of the base 200 is variable, and the number of modules that are in the base 200 can correspond to the intelligence of the base 200, or in other embodiments an exemplary base with a plurality of features can be made to emulate a base with less features. For example, in some embodiments, the base 200 can perform only a recharging function through recharging module 230. In other embodiments, the base 200 can additionally provide a communication link to a managing computer through communication interface 210.

In some embodiments of the invention, the recharging module 230 can also comprises the power source charging module 127 described in FIG. 1. Such a base can recharge devices that do not have a power source charging module 127 and/or it can recharge devices with a power source charging module by bypassing the module 127 or telling the device 100 to turn the module 127 off.

The memory 220 of base 200 can have stored thereon, a number of methods for operating the base 200. For example, the base 200 can be modified to perform device management through device management method 265. Device management can include, for example, address pairing between a base 200 and a device 100.

In addition, in an exemplary embodiment of the invention, base-side power source charging method 260 can be used to charge the power source of a device. For example, when power is supplied to the base 200, side power source charging method 260 determines the types of power supplies coupled to the base 200, and chooses one or more to use for power and to recharge the power supply of a device. In an embodiment of the invention, the method 260 has a preference for a higher capacity power supply. Device management method 265 and base side power source charging method 260 can be stored in memory 220, in an embodiment. Memory 220 can be similar to the memory 120 of device 100.

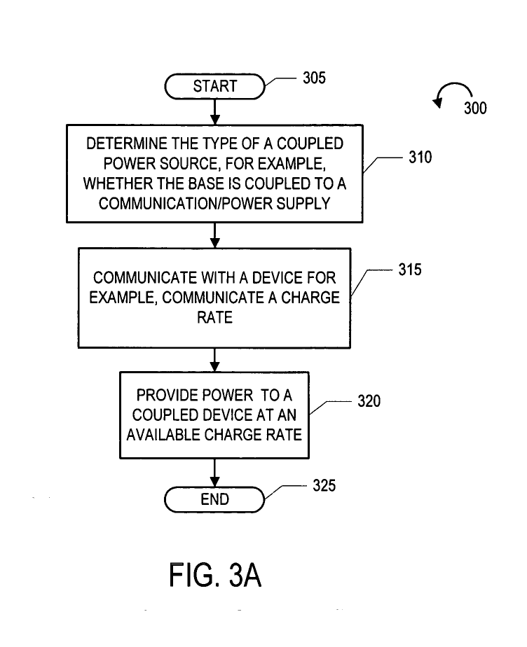

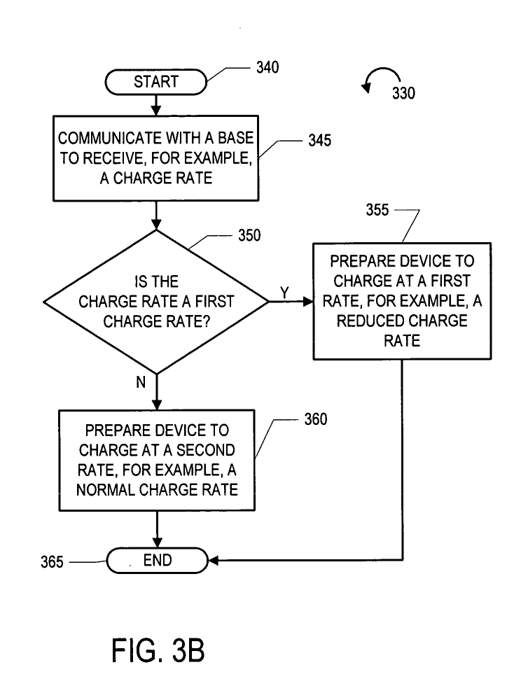

FIG. 3A illustrates an exemplary base side power source charging method 300 implemented in accordance with an embodiment of the invention. In embodiments of the invention, the method 300 can be implemented as the base side power source method 260 of base 200.

Method 300 starts in step 305, for example, when a base 200 receives power and/or is turned on. Processing proceeds to step 310, where the base 200 determines the type of a coupled power source, for example, the base 200 can be coupled to a 110-volt outlet and/or the base can be coupled to a communication/power supply interface such as a USB interface. In an embodiment, the base can have a preference to use the higher capacity power supply. In alternate embodiments, the plurality of different powers source can be combined.

Following step 310, processing proceeds to step 315, where the base 200 communicates with a device 100, for example the base 200 communicates a charge rate to the device 100. The communication can be an electrical signal representing a charge rate and/or in alternate embodiments, the communication can be part of a messaging protocol between the base 200 and the device 100. The communication can occur through an electrical connection between the base 200 and the device 100, and/or in alternate embodiments, the base 200 and the device 100 can communicate wirelessly before the device 100 is couple to the base 200.

In an alternate embodiment of the invention, the base 200 further comprises a power source charging module 127. In this embodiment, the communication step 315, can comprise an instruction to the device 100 to turn off its power source charging module 127. Additionally, the base 200, through processing unit 205, can communicate with its power source charging module 127 to prepare the module to charge at an available charge rate.

Returning to step 315 of FIG. 3A, the base 200, in one exemplary embodiment, communicates to a device 100 to charge at a normal rate or a reduced rate. In alternate embodiments, the base 200 can choose from a plurality of different rates. FIG. 3B illustrates an exemplary power source charging method 330 that can be implemented as power source charging method 160 of device 100. Method 330 starts in step 430, for example when a device 100 is coupled to a base 200.

Processing proceeds to step 345, where the device communicates with a base 200. The communication can comprise a charge rate at which the device 100 can charge its power source. Following step 345, processing proceeds to step 350 where the device 100 determines whether to charge at a first rate or a second rate. If the communication from the base 200 indicates to the device 100 to charge at a first rate, processing proceeds to step 355. In step 355, the device 100 prepares to charge at a first rate. In one exemplary embodiment, the first rate can be a reduced rate. In the embodiment where the device 100 comprises two or more current sources, a reduced charge rate can be achieved by using one current source. Following step 355, processing of method 330 ends in step 365.

Returning to step 350, if the communication from the base 200 indicates that the device 100 can charge at a second rate, processing proceeds from step 350, to step 360. In step 360, the device 100 prepares to charge its power source at a second rate. In an exemplary embodiment, the second rate can be a normal/full charge rate. In the embodiment where the device 100 comprises two or more current sources, a normal/full charge rate can be achieved by activating all the available current sources. In an embodiment, the power source charging module 127 of a device 100 can comprise two current sources. One current source is always on, and the other current source is turn on, under control of the processing unit 105, when a full charge rate is available. Following step 360, processing of method 330 ends in step 365.

Returning to step 315 of FIG. 3A, processing proceeds from step 315 to step 320, where the base 320 provides power to a coupled device 100 at an available charge rate. Since, in an embodiment of the invention, the base 200 communicates the appropriate charge rate to the coupled device 100, and the device prepares to charge at that appropriate rate, the device 100 can charge at any rate that is available to the base. Therefore, the device will automatically charge whether the base 200 is powered by a high capacity supply or a low capacity supply. Processing of method 300 ends in step 325, for example, when the device's power source is charged.

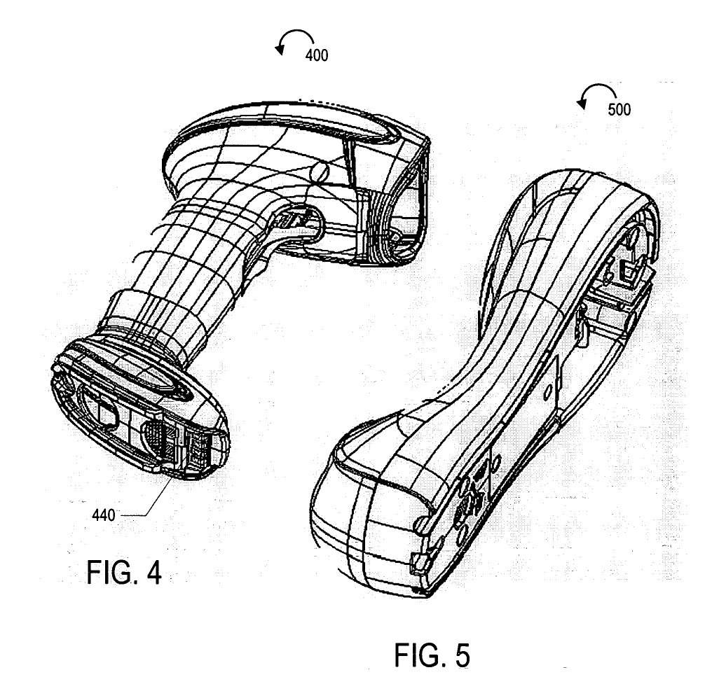

FIGS. 4-7 illustrate an exemplary scanner 400 and cradle 500 implemented in accordance with an embodiment of the invention. FIG. 4 illustrates a wire frame diagram of an exemplary scanner 400. The scanner 400 comprises four contacts 440 on the bottom of it handle. Two of the contacts are used to recharge the scanner's 400 power source and the other two contacts are used to transfer data between the scanner 400 and the cradle 500.

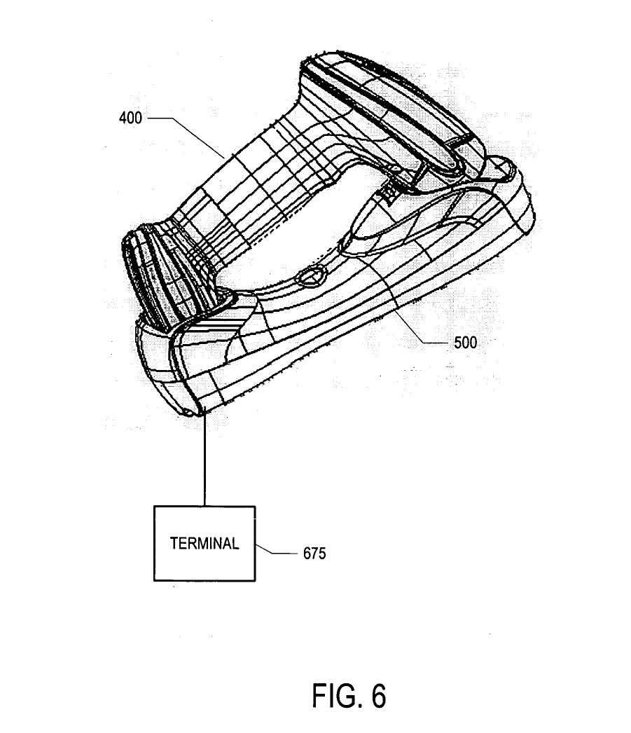

FIG. 5 illustrates an exemplary cradle 500 implemented in accordance with an embodiment of the invention. The cradle 500 comprises a first receiving structure positioned on the top of the cradle 500 for receiving the head of the scanner 400 and a second receiving structure positioned at the bottom of the cradle 500 for receiving the handle of the scanner. The second receiving structure comprises four contacts (not shown) that correspond to the contacts 440 on the bottom of the scanner 400. When the scanner 400 is place in the cradle 500 as illustrated in FIG. 6, the contacts 440 of the scanner 100 and the contacts of the cradle 500 are aligned to form a connection. As mentioned above the connection can be used to transfer data to and from the scanner 400 and to charge the power source of the scanner 400.

As illustrated in FIG. 6, the base can be coupled to a terminal 675, such as for example a POS terminal. The connection can be through a USB interface which the cradle 500 can use for communications with the POS terminal 675. The POS terminal 675 can be coupled to another computer from which it receives product information, updates, etc. The POS terminal 675 can also act as a USB host and provide power to the cradle 500. The cradle 500 can also be coupled to another external power supply, such as, for example, a 110-volt outlet.

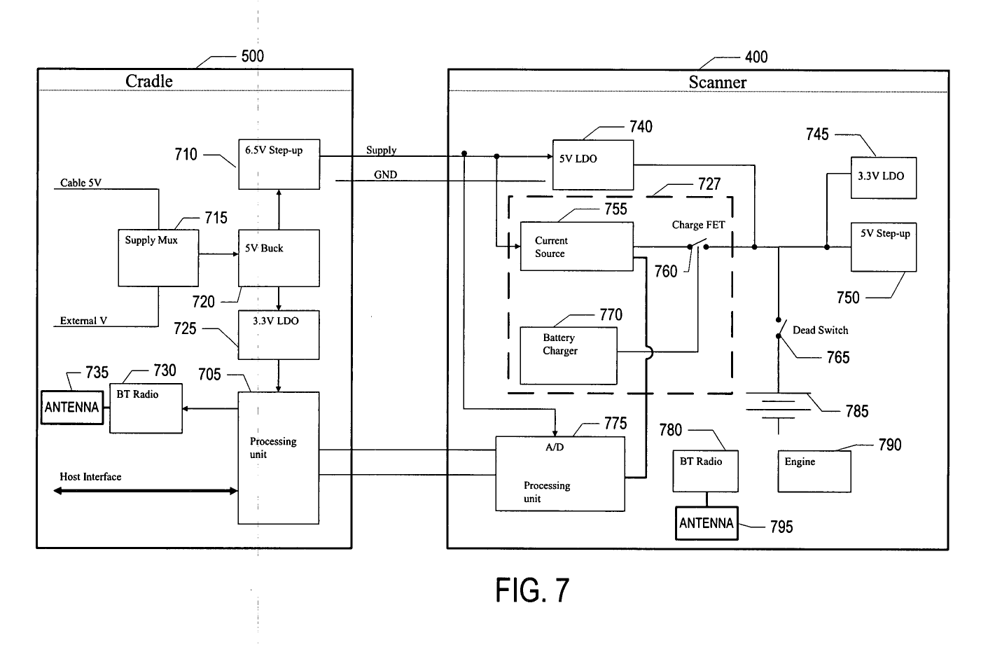

FIG. 7 illustrates an exemplary block diagram of scanner 400 and cradle 500. Cradle 500 comprises a 6.5V step-up module 710, a supply mux 715, a 5 volt buck 720, a 3.3V LDO (low dropout) regulator 725, a processing unit 705, a radio 730 and an antenna 735. The scanner 400 comprises a 5V LDO 740, a current source 755, a battery charger 770, a charge FET 760, a dead switch 765, a battery 785, a 3.3V LDO 745, a 5V step-up 750, a processing unit 775, a scan engine 790, a radio 780 and an antenna 795.

The cradle can obtain power from a plurality of different sources. For example, power can be supplied from a 5V cable, such as, for example, a USB cable, coming from the terminal, or power can be supplied by an external power source, such as for example from an electrical outlet or from another battery. The supply mux 715 detects which line is providing the cradle with power and sends the power to 5V buck regulator 720, which maintains a 5V voltage.

The 5V buck 720 is coupled to the 6.5V step-up 710 and the 3.3V LDO 725. The 6.5 V step-up is coupled to the cradle's 500 contacts which are coupled to the contacts of the scanner 400. One contact can be a supply line while the other contact can be a ground. The 3.3V LDO is coupled to the processing unit 705. The processing unit 705 is coupled to the radio 730, and the radio 730 is coupled to an antenna 735. The cradle 500 can use the radio 730 and antenna 735 to communicate with the scanner 400 when the scanner is operating in a mobile mode. The exemplary cradle 500 of FIG. 7 also comprises a processing unit 705 that has a connection to a host interface. The host interface can be a USB interface coupled to a POS terminal host.

In an exemplary embodiment, the cradle 500 can determine whether it is coupled to a USB host by sending pulses on unused USB pins that are shorted. If the cradle 500 receives the same pulses as it outputs, then it is coupled to a USB host.

In alternate embodiments the cradle 500 can communicate with a terminal using the radio 730 and antenna 735 instead of a USB connection.

The processing unit 705 can also be coupled to the contacts of cradle 500. When a scanner 400 is placed in the cradle 500 the contacts of the cradle 500 make a connection with the contacts of the scanner 400. The contacts of the scanner are coupled to a processing unit 775 in the scanner 400. Thus, the cradle 500 and the scanner 400 can communicate information, including a charge rate, between each other through this connection.

As mentioned above, the scanner 400 also has two contacts for receiving power from the cradle 500. The supply line is coupled to the 5V LDO 740, the current source 755 and an analog to digital converter in the processing unit 775. The current source 755 is coupled to one prong of the charge FET 760, the 5V LDO 740 is coupled to a second prong of the charge FET 760 and the battery charger 770 is coupled to a third prong of the charge FET 760. The current source is also coupled to the processing unit 775. The second prong of the charge FET 760 is also coupled to a bus coupling the 3.3V LDO 745, the 5V step-up 750 and the dead switch 765. The other end of the dead switch 765 is coupled to the scanner's 400 power source 785.

The connections between the modules in the scanner 400 are exemplary and may not be complete. Additional communications channels, which are not shown, can exist between the various modules of the scanner 400. In addition, the communication channels between the modules of the cradle 500 are also exemplary and may not be complete. Additional communications channels, which are not shown, can exist between the various modules of the cradle 500.

The 3.3V LDO 745 provides a consistent 3.3 volts to the processing unit 775 and the radio 780, while the 5V step-up 750 provides power to the scan engine 790. The scanner 400 can use the radio 780 and the antenna 795 to communicate with the base 500 when the scanner 400 is in a mobile mode.

In an exemplary recharging operation, the supply mux 715 chooses an available power source. When both power sources types are available, the supply mux 715 chooses the external voltage because it has a higher current capacity. Then, the cradle 500 determines which power source the supply mux 715 has chosen and stores that information. The cradle 500 then uses that selection information to choose an appropriate charge rate for a scanner 400.

When a scanner 400 is coupled to the cradle 500, the cradle 500 and the scanner 400 communicate with each other. In one embodiment, the cradle 500 sends a message to the scanner 400, informing it to charge at a particular rate. Using the charge rate information received from the cradle 500, the scanner 400, through processing unit 775, adjusts a power source charging module 127 to charge at the received rate. The battery charger 770 turns on the charge FET 760, and the battery begins to charge. Thus, the scanner 400 automatically charges from either the 5V cable or the external voltage.

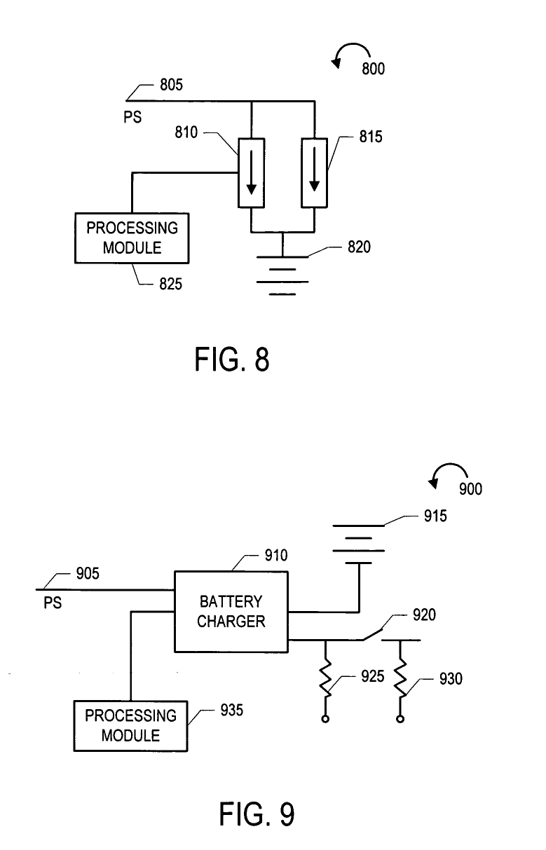

The power source charging module 127, comprises current source 755, battery charger 770 and charge FET 760. FIGS. 8 and 9 illustrate two different power source charging modules 800, 900 that maybe used in different embodiments of the invention. In alternate embodiments of the invention, any module that can control current levels may be used as a power source charging module 127.

Exemplary scanner 400 comprises a nickel metal hydride power source 785 and the current source 755 can be implemented with a module similar to the power source charging module 800 illustrated in FIG. 8. Power source charging module 800 comprises a power supply line 805 that is coupled to two current sources 810, 815. The current sources 810, 185 are also coupled to a power source 820. One of the current sources 810, is coupled to and controlled by processing module 825.

In this exemplary embodiment, when the scanner 400 charges at a reduced rate, the processing module 825 does not activate current source 810, and the power source 820 only draws power from current source 815. In one exemplary embodiment, the maximum current draw of the current source 815 can be set to correlate with the lower capacity power supply available to the cradle 500. The maximum current draw from a USB host is 500 mA. When the scanner 400 charges at a full charge rate, the processing module 825 activates the other current source 810, and the power supply 820 draws power from both current sources 810, 815. Thus, the scanner 400 draws the proper amount of current from the cradle 500, and a USB host coupled to the cradle 500 will not shut off power to the cradle 500 for drawing too much current.

In an alternate embodiment, an electronic device may have a lithium ion battery as a power supply. In this embodiment, a current source may not be needed and a power source charging module 127 similar to the module 900 illustrated in FIG. 9 may be implemented.

The power source charging module 900 illustrated in FIG. 9 comprises a battery charger 910, a power source 915, a processing module 935, two resistors and a switch 920. The battery charger 910 draws current from a power supply line 905, and charges a coupled power source 915. The level of current that the battery charger 910 draws from the line 905 can be controlled, through the processing module 935, by the switch 920 and the two resistors 925, 930.

In an exemplary embodiment, when the switch 902 can be turned off and on to control the charge rate of the battery charger 910. When the switch is off the battery charger 910 reads resistor 925, and charges the battery 915 at a reduced rate. When the switch is on, the battery charger 910 read both resistors 925, 930 and charges the battery 915 at a maximum rate. The battery charge 910 can be scaled to charge at a pluarality of different rates by adding additional resistors.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of charging a power source comprising:
determining a type of power supply used by a base;
communicating a charge rate to a power source charging module; and
providing power to said power source at said charge rate.

2. The method of claim 1, wherein the step of communicating a charge rate to a power source charging module is performed before a device is coupled to said base for charging.

3. The method of claim 1, wherein said power source charging module is located in a device, said device comprising a rechargeable power source.

4. The method of claim 1, wherein the step of communicating a charge rate to a power source charging module is communicated as part of a communication protocol between said base and a device.

5. The method of claim 1, further comprising preparing to charge said power source based on said type of power supply.

6. The method of claim 5, wherein the step of preparing to charge said power source based on said type of power supply comprises sending a signal to a current control module to charge said power source at a charge rate based on the type of power supply used by said base.

7. The method of claim 6, wherein said current control module comprises at least one of a current source and a power source charger.

8. The method of claim 1, wherein the step of determining a type of a power supply used by a base comprises:
determining whether said base is coupled to a dedicated power supply; and
determining whether said base is coupled to a hybrid communication and power supply when a negative determination is made on the dedicated power supply.

9. The method of claim 8, wherein said hybrid communication and power supply is at least one of a universal serial bus system and an IEEE 1394 system.

10. A charging base comprising:
a multiplexing module for selecting an available power supply;
a processing unit; and
memory having stored thereon at least one process for,
determining a type of power supply used by said base,
communicating a charge rate to a power source charging module, and
providing power to a power source at said charge rate.

11. The charging base of claim 10, wherein said multiplexing module selects one of a dedicated power supply and a hybrid communication and power supply.

12. The charging base of claim 10, further-comprising-a communication module and an antenna for wireless communication with a device.

13. The charging base of claim 10, wherein said charging base is coupled to a point of sale terminal.

14. The charging base of claim 10, wherein said at least one process further comprises preparing to charge a power source based on said type of power supply.

15. The charging base of claim 14, further comprising a current control module, and wherein the step of preparing to charge a power source based on said type of power supply comprises sending a signal to said current control module to charge said power source at a charge rate based on the type of power supply used by said base.

16. A computing device comprising:
a power source;
a processing unit; and
memory having stored thereon at least one process for,
communicating with a base to determine a charge rate, and
receiving power from said base at said charge rate.

17. The computing device of claim 16, further comprising a communication module and an antenna for wireless communication with a base.

18. The computing device of claim 16, wherein said power source is one of a nickel metal hydride battery and a lithium ion battery.

19. The computing device of claim 16, wherein said computing device is a dataform scanner.

20. The computing device of claim 16, wherein said at least one process further comprises preparing to charge said power source based on said type of power supply used by said base.

21. The computing device of claim 20, further comprising a current control module, and wherein the step of preparing to charge said power source based on said type of power supply comprises sending a signal to said current control module to charge said power source at a charge rate based on the type of power supply used by said base.

22. The computing device of claim 21, wherein said current control module comprises at least one of a current source and a power source charger.

23. The computing device of claim 22, wherein said current control device comprises at least two current sources, and said charge rate is adjusted by the number of current sources that are used.
